(19) United States
(12) Patent Application Publication
(10) Pub. No.: US 2017/0242854 A1
(43) Pub. Date: Aug. 24, 2017

(54) DATASET SAMPLING THAT IS INDEPENDENT OF RECORD ORDER

(71) Applicant: International Business Machines Corporation, Armonk, NY (US)

(72) Inventors: Dong Liang, Xi'an (CN); Bo Song, Xi'an (CN); Jun Wang, Xi'an (CN); Jing Xu, Xi'an (CN); Ji Hui Yang, Xi'an (CN)

(21) Appl. No.: 15/051,086

(22) Filed: Feb. 23, 2016

(51) Int. Cl. G06F 17/30

(52) U.S. Cl. CPC G06F 17/3033; G06F 17/30345; G06F 17/30339

(57) ABSTRACT

A first data record and a second data record are received, wherein the first data record is one of a number of data records of a first dataset and the second data record is one of a number of data records of a second dataset. A first random seed for the first data record and a second random seed for the second data record are generated, wherein both random seeds are equal responsive to determining that the first data record and the second data record represent the same data. A first sampling parameter for the first data record and a second sampling parameter for the second data record using a random number generator are generated. The first data record and the second data record are selected for a first sample dataset and second sample dataset, respectively, based on the generated sampling parameters.

### STATEMENT REGARDING PRIOR DISCLOSURES BY THE INVENTOR OR A JOINT INVENTOR

Aspects of the present invention have been disclosed by another, who obtained the subject matter disclosed directly from the inventors, in the products IBM SPSS Modeler V17.1, IBM SPSS Predictive Analytics Enterprise V3.1, and IBM SPSS Analytic Server V2.1, all made available to the public on Sep. 15, 2015. These aspects, as they may appear in the claims, may be subject to consideration under 35 U.S.C. §102(b)(1)(A).

### FIELD OF THE INVENTION

The present invention relates generally to the field of statistical sampling, and more particularly to implementing a method for sampling a dataset.

### SUMMARY

Embodiments of the present invention provide systems, methods, and computer program products. A first data record from a first population dataset that includes a number of data records, and a second data record from a second population dataset that includes a number of data records, is retrieved. A first random seed is generated for the first data record by applying a first mapping function to values of elements in the first data record, and a second random seed is generated for the second data record by applying a second mapping function to values of elements in the second data record, wherein, responsive to determining that the elements in the first data record represent the same data as the elements in the second data record, a value of the first random seed is equal to a value the second random seed. A first sampling parameter is generated for the first data record and a second sampling parameter is generated for the second data record using a random number generator, wherein, responsive to determining that the value of the first random seed is equal to the value of the second random seed, the first sampling parameter is equal to the second sampling parameter. Responsive to determining that the first sampling parameter fulfills a sampling rule, the first data record for a first sample dataset is selected. Responsive to determining that the second sampling parameter fulfills the sampling rule, the second data record for the second sample dataset is selected.

### BRIEF DESCRIPTION OF THE DRAWINGS

FIG. 1 is a block diagram of a sampling system, in accordance with an embodiment of the present invention;

FIG. 2A is a table illustrating a population dataset having a first record order, in accordance with an embodiment of the present invention;

FIG. 2B is a table illustrating a population dataset having a first record order, in accordance with an embodiment of the present invention;

FIG. 3 is a table illustrating a population dataset having a first record order, after generating a random seed and a sampling parameter for each formatted data record, in accordance with an embodiment of the present invention;

FIG. 4 is a table illustrating a sample dataset that is generated from a population dataset having a first record order, in accordance with an embodiment of the present invention;

FIG. 5A is a table illustrating a population dataset having a second record order, in accordance with an embodiment of the present invention;

FIG. 5B is a table illustrating a population dataset having a second record order, after generating a random seed and sampling parameter for each formatted data record, in accordance with an embodiment of the present invention;

FIG. 6 is a table illustrating a sample dataset that is generated from a population dataset having a second record order, in accordance with an embodiment of the present invention;

FIG. 7 is a flowchart illustrating operational steps for generating a sample dataset, in accordance with an embodiment of the present invention;

FIG. 8 is a block diagram of internal and external components of the computer systems of FIG. 1, in accordance with an embodiment of the present invention;

FIG. 9 depicts a cloud computing environment, in accordance with an embodiment of the present invention; and

FIG. 10 depicts abstraction model layers, in accordance with an embodiment of the present invention.

### DETAILED DESCRIPTION

A population dataset includes a number data records, where each data record is a basic data structure that includes fields, or elements, that contain information. Estimating characteristics of a population dataset with a large number of data records may involve analysis that is computationally demanding and time intensive. Sample datasets may be used to reduce the amount of resources used to analyze a large dataset by analyzing a selected portion of the data records from the population dataset.

A random sampling technique, such as simple random sampling without replacement, can be used to generate a sample dataset, such that each data record of a population dataset has an equal probability of being selected for the generated sample dataset. A sampling scheme can use a random number dataset that is generated from a random number generator (RNG) to select one or more data records from a population dataset for a sample dataset.

A random seed is a number or vector that is used to initialize a RNG. The same random seed used by the same RNG (i.e., the same algorithm), will always generate the same result (e.g., a random number, a random number dataset, etc.).

A record order of a population dataset may be based on an initial ordinal number order of the data records in the population dataset. Sorting data records in a population dataset can change the record order of the population dataset, based on the initial ordinal number order of the data records in the dataset. For example, a first population dataset can be a financial services data table. Each data record in the first population dataset includes data elements such as: a name of a financial service account holder, a date that the financial service account was opened, and an account number of the financial service account. The first population dataset has a record order. For example, the data records are organized in a chronological order with respect to a date that the financial service account was opened. A sampling scheme can sort the first population dataset to generate a second population dataset, where the second population dataset has a new record order, such that the data records are organized in an ascending order with respect to a value of the account number of the financial service account. The sampling system can generate a first sample dataset, based on a random seed, from the first population dataset and a second sample dataset, based on the same random seed, from the second population dataset. Here, assume that the first sample dataset and the second sample dataset differ by at least one data record. Accordingly, results from estimating characteristics of the first and second sample dataset may differ.

If two population datasets have identical data records, but the two population datasets have different record orders, then a first sample dataset that is generated from the first of two population datasets will differ from a second sample dataset that is generated from the second of two population datasets. The results from analyzing the two sample datasets will differ as well, even though the two population datasets from which the two sample datasets originate contain data records that represent the same data and are in the same format. A user that is attempting to estimate characteristics of the population datasets may find that the different results from analyzing the two sample datasets is not desirable, because the estimated characteristics for each of the population datasets are different, even though the population datasets contain data records that represent the same data and are in the same format.

Embodiments of the present invention provide methods, systems, and computer program products for generating a sample dataset from more than one population dataset having the same data records in a different record order.

Generally, each data record of a population dataset is associated with a generated random seed and a generated sampling parameter. A sampling rule is applied to each data record to determine whether to select a data record of a sample dataset.

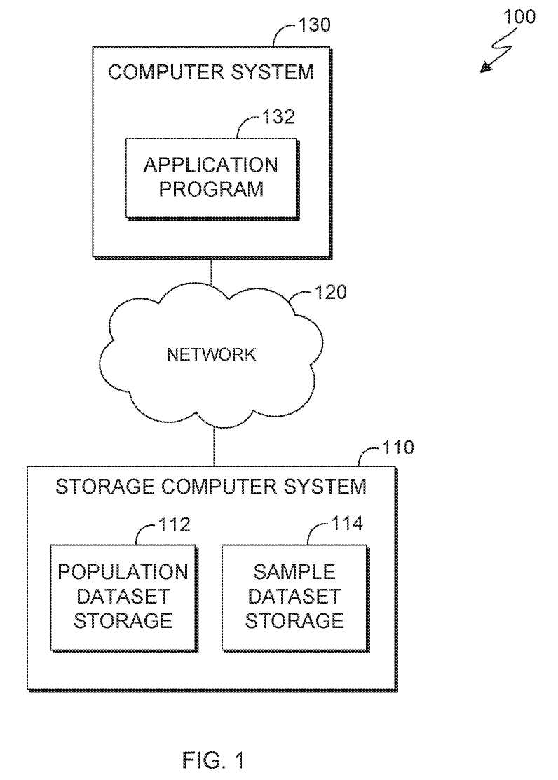

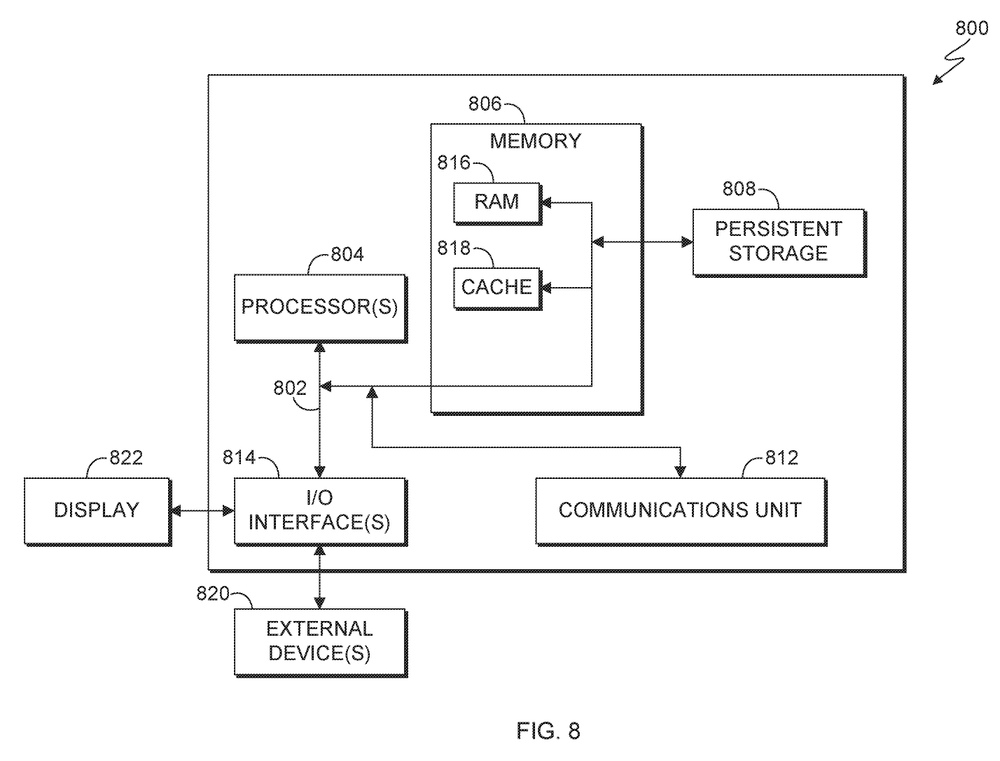

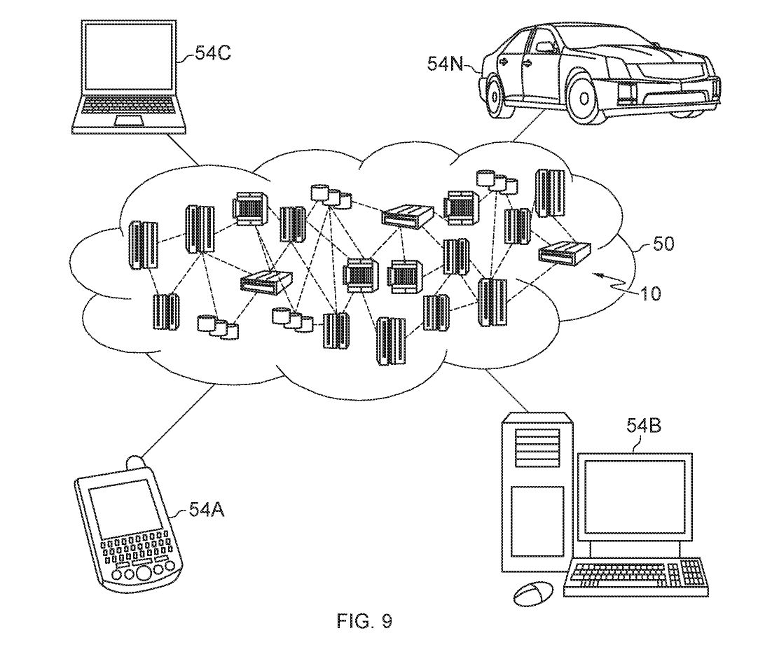

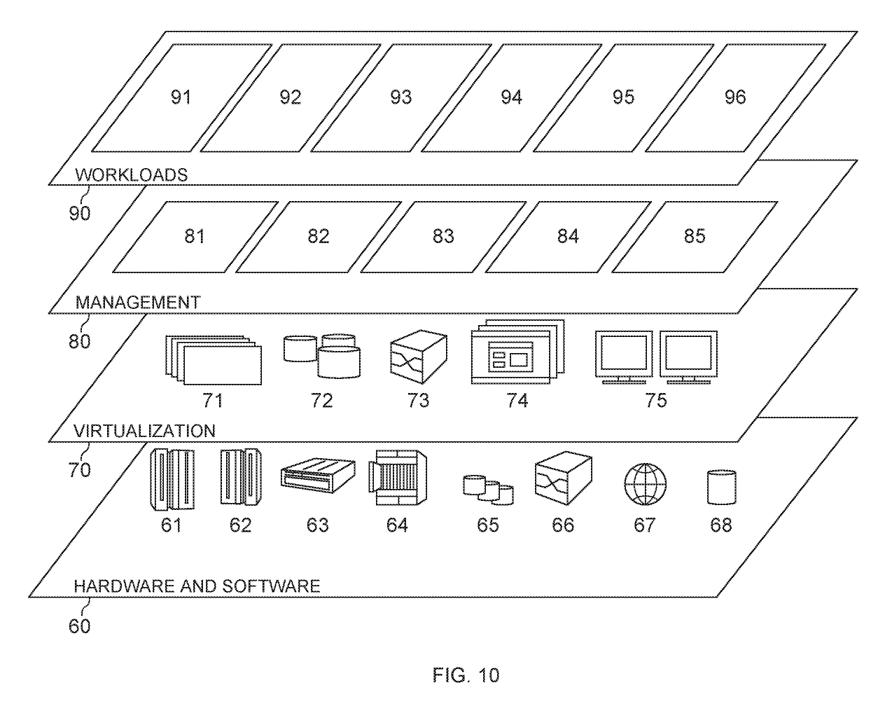

FIG. 1 is a block diagram of sampling system 100, in accordance with an embodiment of the present invention. Sampling system 100 includes storage computer system 110 and computer system 130, which are connected via network 120. Storage computer system 110 and computer system 130 can be desktop computers, laptop computers, specialized computer servers, or any other computer systems known in the art. In certain embodiments, storage computer system 110 and computer system 130 represent computer systems utilizing clustered computers and components to act as a single pool of seamless resources when accessed through network 120. For example, such embodiments may be used in data center, cloud computing, storage area network (SAN), and network attached storage (NAS) applications. In certain embodiments, storage computer system 110 and computer system 130 represent virtual machines. In general, storage computer system 110 and computer system 130 are representative of any electronic devices, or combination of electronic devices, capable of executing machine-readable program instructions, in accordance with an embodiment of the present invention, as described in greater detail with regard to FIG. 8. Sampling system 100 can include a greater or lesser number of computer systems similar to that of storage computer system 110 and computer system 130 that are connected via network 120. In other embodiments, storage computer system 110 and computer system 130 may be implemented in a cloud computing environment, as described in greater detail with regard to FIGS. 9 and 10.

Network 120 can be, for example, a local area network (LAN), a wide area network (WAN) such as the Internet, or a combination of the two, and include wired, wireless, or fiber optic connections. In general, network 120 can be any combination of connections and protocols that will support communications between storage computer system 110 and computer system 130, in accordance with an embodiment of the invention.

Client computer system 130 represents a platform that supports application program 132, which represents program functionality for formatting a data record, generating a random seed for the data record, generating a sampling parameter for the data record in a population dataset, and determining whether the data record is selected for a sample dataset.

Storage computer system 110 represents a platform that includes memory storage to store a population dataset and a sample dataset in population dataset storage 112 and sample dataset storage 114, respectively. In another embodiment, population dataset storage 112 and sample dataset storage 114 can be a part of client computer system 130.

Application program 132 can retrieve a data record from a population dataset that is stored in population dataset storage 112. Elements of a data record can be in different formats. A “formatted data record,” as used herein, refers to a data record where each element of the data record is in a numeric format. For example, application program 132 may retrieve a data record containing a date, where a “year” element of the data record is a numeric value (e.g., 2007), a “month” element of the data record is a character string (e.g., May), and a “day-of-month” element of the data record is a numeric value (e.g., 11). In this embodiment, application program 132 formats the retrieved data record into a formatted data record, such that each element of the data record (i.e., “year,” “month,” and “day-of-month”) are in a numeric format (e.g., [2007, 05, 11]). In one embodiment, application program 132 may use a hash function to format a data record. For example, a hash function can be applied to elements of a data record to return a hash code or hash value that is in a numeric format. In another embodiment, application program 132 can implement encoding strategies to format a data record. For example, a character encoding scheme, such as American Standard Code for Information Interchange (ASCII), can be applied to encode alphanumeric characters into seven-bit integers.

Application program 132 generates a random seed for each retrieved data record from a population dataset. Application program 132 initializes a RNG with a random seed for a retrieved data record, where a result of the RNG for the retrieved data record, a “sampling parameter,” is used to determine whether to select the retrieved data record for a sample dataset. In this embodiment, application program 132 uses a mapping function to generate a random seed. The mapping function refers to a mathematical equation that uses element values of a formatted data record as an input to generate a random seed for the formatted data record. In one embodiment, the mapping function can be a linear or a non-linear mathematical equation that operates on the element values. For example, a random linear model can be used to produce a random seed, Rᵢ, for a formatted data record, Xᵢ, such as Rᵢ=Xᵢ*β, where β is a vector of random coefficients, and Xᵢ is the vector of formatted record element values for the ith record. In another embodiment, application program 132 can use a first mapping function to generate a first random seed for a first retrieved data record, and use a second mapping function to generate a second random seed for a next retrieved data record. In certain embodiments, if two population datasets contain one or more data records that are identical, then application program 132 uses the same mapping function to generate the same random seed for the identical data records, regardless of a record order for each of the more than one population dataset.

Application program 132 selects a retrieved data record from population dataset storage 112 for writing to a sample dataset storage 114, based on a sampling rule. A “sampling rule,” as used herein, refers to a set of rules that application program 132 references to determine whether a retrieved data record is written to a sample dataset. For example, a sampling rule may state that a retrieved data record is selected if a sampling parameter for the retrieved data record is equal to a specified sampling parameter. A “sampling parameter,” as used herein, refers to a result of a RNG that corresponds to a retrieved data record from a population dataset, wherein the RNG is initialized by a random seed for the retrieved data record. For example, a sampling parameter for a data record can be either 0 or 1. In this embodiment, each retrieved data record is associated with a generated random seed, based on the mapping function, and a sampling parameter generated by the RNG using the random seed.

In one embodiment, application program 132 determines that sampling of a population dataset stored in population dataset storage 112 is complete, when a number of data records in the sample dataset stored in sample dataset storage 114 is equal to a specified number of sample records. For example, an administrative user may specify a sample size of five data records for a sample dataset. In this example, application program 132 determines that sampling is complete once five data records from a population dataset have been written to the sample dataset.

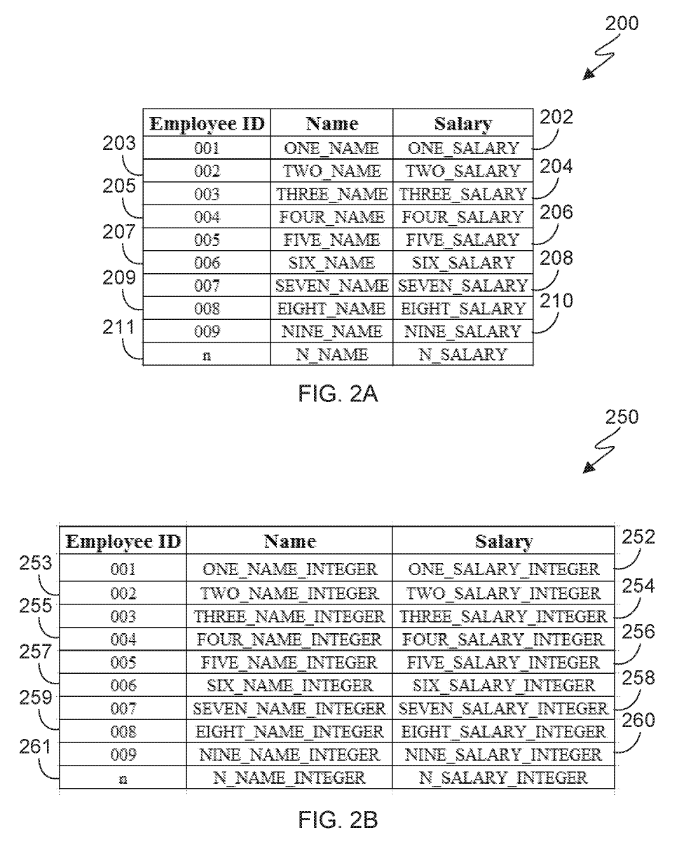

FIG. 2A is table 200 illustrating a population dataset with a first record order, in accordance with an embodiment of the present invention. In this embodiment, the population dataset includes data records 202-211, where each of data records includes three elements: Employee ID, Name, and Salary. Application program 132 retrieves each of data records 202-211 from population dataset storage 112, and processes each of data records to determine if one or more of data records 202-211 are selected for a sample dataset. As previously described, application program 132 retrieves data records 202-211, formats data records if necessary, and applies a mapping function to generate a random seed for each of data records 202-211, requiring formatted data records. In this embodiment, application program 132 determines that each of data records 202-211 have elements, “Name” and “Salary,” which are not in a numerical format, and require formatting.

FIG. 2B is table 250 illustrating a population dataset having a first record order, in accordance with an embodiment of the present invention. Application program 132 formats data records 202-211 into formatted data records 252-261. In this embodiment, formatted data records 252-261 represent the same data as data records 202-211.

For example, application program 132 can retrieve data record 211, [n, N_NAME, N_SALARY], where n=11, N_NAME=ROBERT, and N_SALARY=FIVE THOUSAND. In this example, data record 211, [11, ROBERT, FIVE THOUSAND], has two elements that are not in a numerical format: ROBERT and FIVE THOUSAND. Application program 132 formats ROBERT and FIVE THOUSAND, such that each element of data record 211 is represented in a numeric format. As a result, application program 132 generates formatted data record 252, [n, N_NAME_INTEGER, N_SALARY_INTEGER], where n=11, N_NAME_INTEGER=12345, N_SALARY_INTEGER=5000. For example, a hash function can be applied to ROBERT to produce a hash code, 12345.

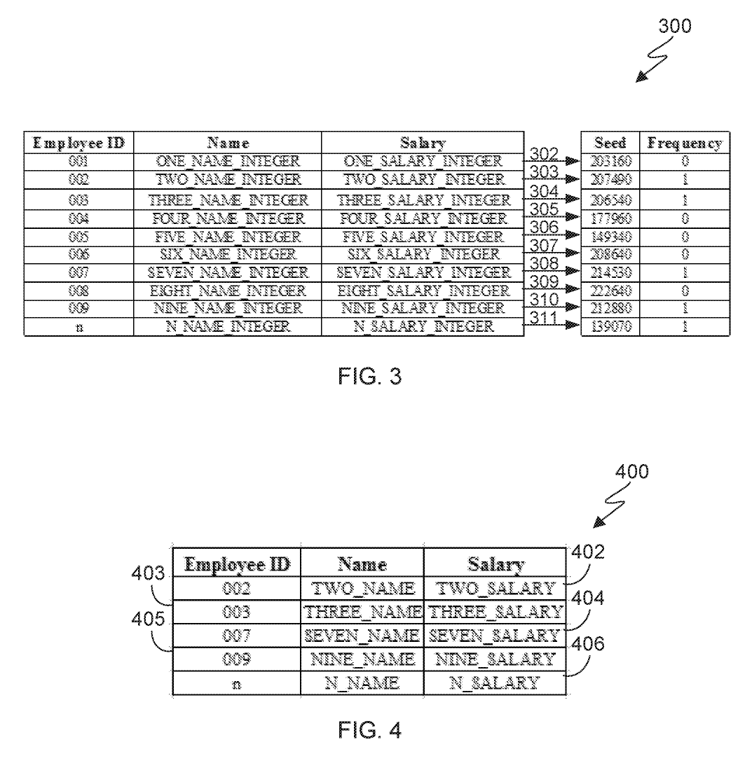

FIG. 3 is table 300 illustrating a population dataset having a first record order, that includes a random seed and a sampling parameter for each of formatted data records 302-311, in accordance with an embodiment of the present invention. In this embodiment, the population dataset includes formatted data records 302-311 that represent the same data, and are in the same format as, formatted data records 252-261 of FIG. 2B. Random seeds and sampling parameters for each of formatted data records 302-311 are provided for illustrative purposes, and may be stored in a separate associated data table than the population dataset having the first record order. Each of formatted data records 302-311 is associated with a generated random seed and a sampling parameter. In this embodiment, application program 132 uses a mapping function to generate a random seed for each of formatted data records 302-311. For example, a random seed, 212880, is generated for formatted data record 310. Application program 132 uses the random seed, 212880, to initialize an RNG. The RNG generates a sampling parameter for formatted data record 310 equal to 1.

In this embodiment, a sampling parameter for each of formatted data records 302-311 is equal to either 0 or 1. As previously described, application program 132 utilizes a sampling rule to determine whether a formatted data record 302-311 is selected for inclusion in a sample dataset. For example, a sampling rule may select any data records 302-311 having a sampling parameter equal to 1 for a sample dataset. In this embodiment, application program 132 determines that formatted data record 302 has a sampling parameter equal to 0, whereby application program 132 does not select the formatted data record 302 for the sample dataset. Alternatively, application program 132 selects formatted data records 303, 304, 308, 310, and 311 for a sample dataset, based on the sampling parameter being equal to 1.

In another embodiment, a sampling parameter for one of formatted data records 302-311 can be a range of number values, for example, a number value between 0-1000. In this embodiment, a sampling rule indicating that any one of formatted data records 302-311 having a sampling parameter larger than a specified number value, for example, 500, is selected for a sample dataset.

FIG. 4 is table 400 illustrating a sample dataset that is generated from a population dataset, as illustrated in FIG. 3, having a first record order, in accordance with an embodiment of the present invention. In this embodiment, application program 132 determines that sampling is complete, because a number of data records for the sample dataset (i.e., five data records 402-406) is equal to a number of data records specified by the dataset size for the sample dataset. Accordingly, data records 402, 403, 404, 405 and 406 are stored in sample dataset storage 114. In this embodiment, application program 132 reverts the format of the elements in data records 402, 403, 404, 405, and 406 from the data in formatted data records 253, 254, 258, 260, and 261 as presented in FIG. 2B, to the data in data records 203, 204, 208, 210, and 211 as presented in FIG. 2A.

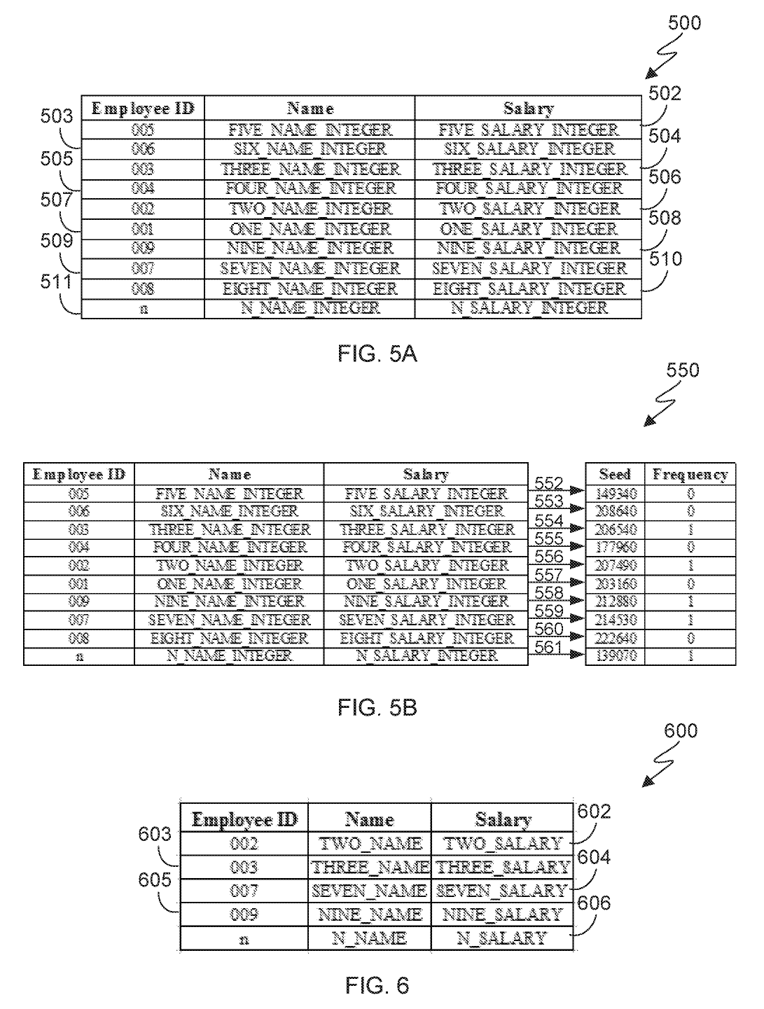

FIG. 5A is table 500 illustrating a population dataset having a second record order, in accordance with an embodiment of the present invention. In this embodiment, the population dataset includes formatted data records 502-511 that represent the same data and are in the same format as formatted data records 252-261 of FIG. 2B, but in a different record order.

FIG. 5B is table 550 illustrating a population dataset having a second record order, after generating a random seed and sampling parameter for each of formatted data records 552-561, in accordance with an embodiment of the present invention. In this embodiment, the population dataset includes formatted data records 552-561 that represent the same data and are in the same format as formatted data records 502-511 of FIG. 5A. Random seeds and sampling parameters for each of formatted data records 502-511 are provided for illustrative purposes, and may be stored in a separate data table than the population dataset having the second record order. In this embodiment, data represented by data records in population datasets of FIG. 5B and FIG. 3 are the same, but are organized in a different fashion (i.e., have different record orders).

As previously described, if more than one population dataset contains identical formatted data records, then application program 132 uses the same mapping function to generate a random seed for the identical formatted data records that appear in the more than one population dataset, regardless of a record order for each of the more than one population dataset. For example, application program 132 generates a random seed, 206540, for formatted data record 304 of the population dataset in FIG. 3, by using a first mapping function. Similarly, application program generates a random seed, 206540, for formatted data record 554 of the population dataset in FIG. 5B, using the first mapping function. In this both instances, application program 132 uses the same input for the first mapping function: [003, THREE_NAME_INTEGER, THREE_SALARY_INTEGER] from formatted data record 304, and [003, THREE_NAME_INTEGER, THREE_SALARY_INTEGER] from formatted data record 554, to generate the same random seed in both instances.

As previously described, if a same random seed is used by the same RNG, then the RNG will generate the same result (i.e., a sampling parameter). In this embodiment, application program 132 uses the same RNG to generate sampling parameters in the population dataset of FIG. 3 and the population dataset of FIG. 5B. For example, application program 132 uses the same RNG to generate a sampling parameter for data record 304 of the population dataset in FIG. 3 and data record 554 of the population dataset in FIG. 5B, resulting two sampling parameters that are equivalent to each other and are equal to 1.

In this embodiment, application program 132 determines whether any one of formatted data records 552-561 are selected for a sample dataset, based on a sampling rule. The sampling rule may specify that application program 132 selects any one of formatted data records 552-561 having a sampling parameter of 1. For example, application program 132 determines that formatted data record 552 has a sampling parameter equal to 0, resulting in application program 132 not selecting formatted data record 552 for the sample dataset. Accordingly, application program 132 selects formatted data records 554, 556, 558, 559, and 561 to be a part of the sample dataset.

FIG. 6 is table 600 illustrating a sample dataset that is generated from a population dataset having a second record order, in accordance with an embodiment of the present invention. In this embodiment, application program 132 determines that sampling is complete, because a number of data records for the sample dataset (i.e., five data records 602-606) is equal to a number of data records specified by the dataset size for the sample dataset. Accordingly, data records 602, 603, 604, 605 and 606 are stored in sample dataset storage 114.

The sample dataset illustrated in FIG. 6 and the sample dataset illustrated in FIG. 4 are identical sample datasets, even though the sample dataset in FIG. 6 was generated from a population dataset having a second record order, and the sample dataset in FIG. 4 was generated from a population dataset having a first record order. Accordingly, application program 132 is configured to reproduce a sample dataset from more than one population datasets for any number of instances, even if each of the more than one population datasets has a different record order, provided that the data represented in data records of each of the more than one population datasets remain the same.

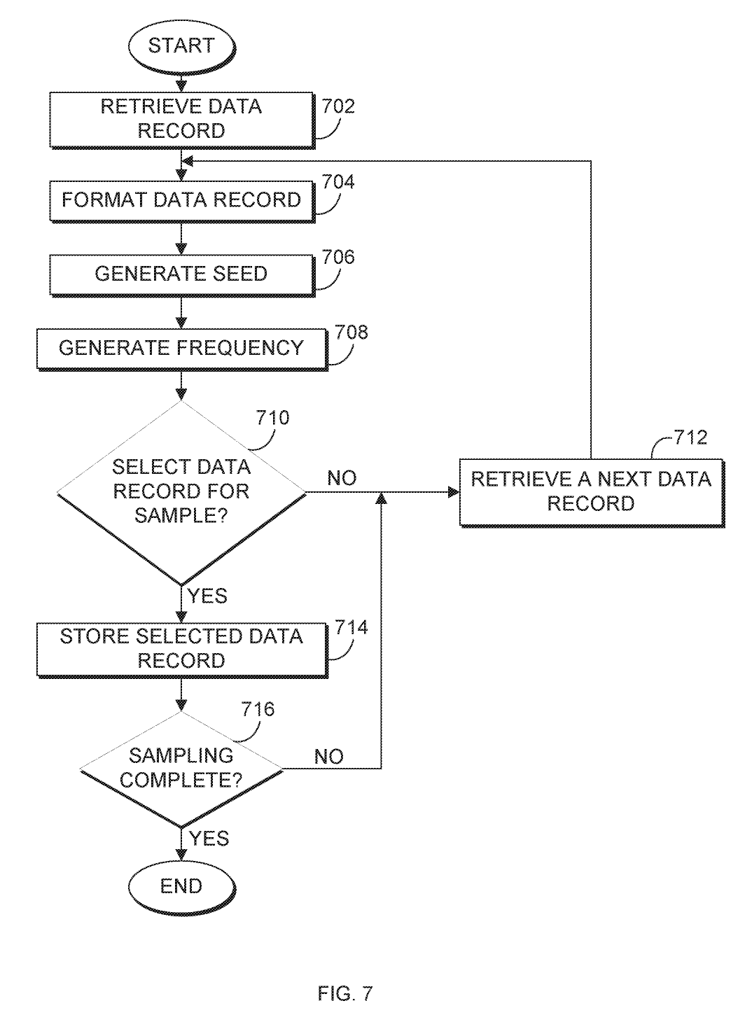

FIG. 7 is a flowchart illustrating operational steps for generating a sample dataset, in accordance with an embodiment of the present invention. Application program 132 retrieves a data record of a population dataset from population dataset storage 112 (step 702). Application program 132 formats the retrieved data record into a formatted data record (step 704). Application program 132 uses the formatted data record and a mapping function to generate a random seed (step 706). Application program 132 initializes an RNG with the random seed and generates a sampling parameter for the retrieved data record.

In this embodiment, application program 132 uses a sampling rule to determine whether the retrieved data record is selected for a sample dataset, based on the generated sampling parameter for the retrieved data record. Application program 132 determines whether to select the retrieved data record, based on a specified sampling rule (decision 710). If, application program 132 determines not to select the retrieved data record for the sample dataset (‘no’ branch, decision 710), then application program 132 retrieves a next data record of the population dataset from population dataset storage 112 (step 712). Application program 132 performs operational steps as described herein on the next data record of the population dataset similar to that of the retrieved data record in step 702. If, application program 132 determines to select the retrieved data record for the sample dataset (‘yes’ branch, decision 710), then application program 132 stores the selected data record for the sample dataset in sample dataset storage 114 (step 714).

After sample dataset storage 114 is updated with the selected data record, application program 132 determines whether sampling is complete (decision 716). In one embodiment, application program 132 determines whether sampling is complete based on whether a current dataset size of the sample dataset is equal to a specified dataset size. If, application program 132 determines that sampling is not complete (‘no’ branch, decision 716), then application program 132 retrieves a next data record of the population dataset. For example, if application program 132 determines that the current dataset size of the sample dataset is four data records, and the specified dataset size is five data records, then application program 132 retrieves a next data record for subsequent analysis. If, application program 132 determines that sampling is complete (‘yes’ branch, decision 716), then application program 132 terminates operational steps as described herein and accordingly generation of the sample dataset is complete.

FIG. 8 is a block diagram of internal and external components of a computer system 800, which is representative the computer systems of FIG. 1, in accordance with an embodiment of the present invention. It should be appreciated that FIG. 8 provides only an illustration of one implementation and does not imply any limitations with regard to the environments in which different embodiments may be implemented. In general, the components illustrated in FIG. 8 are representative of any electronic device capable of executing machine-readable program instructions. Examples of computer systems, environments, and/or configurations that may be represented by the components illustrated in FIG. 8 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 800 includes communications fabric 802, which provides for communications between one or more processors 804, memory 806, persistent storage 808, communications unit 812, and one or more input/output (I/O) interfaces 814. Communications fabric 802 can be implemented with any architecture designed for passing data and/or control information between processors (such as microprocessors, communications and network processors, etc.), system memory, peripheral devices, and any other hardware components within a system. For example, communications fabric 802 can be implemented with one or more buses.

Memory 806 and persistent storage 808 are computer-readable storage media. In this embodiment, memory 806 includes random access memory (RAM) 416 and cache memory 818. In general, memory 806 can include any suitable volatile or non-volatile computer-readable storage media. Software is stored in persistent storage 808 for execution and/or access by one or more of the respective processors 804 via one or more memories of memory 806.

Persistent storage 808 may include, for example, a plurality of magnetic hard disk drives. Alternatively, or in addition to magnetic hard disk drives, persistent storage 808 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 808 can also be removable. For example, a removable hard drive can be used for persistent storage 808. Other examples include optical and magnetic disks, thumb drives, and smart cards that are inserted into a drive for transfer onto another computer-readable storage medium that is also part of persistent storage 808.

Communications unit 812 provides for communications with other computer systems or devices via a network (e.g., network 120). In this exemplary embodiment, communications unit 812 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded through communications unit 812 (e.g., via the Internet, a local area network or other wide area network). From communications unit 812, the software and data can be loaded onto persistent storage 808.

One or more I/O interfaces 814 allow for input and output of data with other devices that may be connected to computer system 800. For example, I/O interface 814 can provide a connection to one or more external devices 820, such as a keyboard, computer mouse, touch screen, virtual keyboard, touch pad, pointing device, or other human interface devices. External devices 820 can also include portable computer-readable storage media such as, for example, thumb drives, portable optical or magnetic disks, and memory cards. I/O interface 814 also connects to display 822.

Display 822 provides a mechanism to display data to a user and can be, for example, a computer monitor. Display 822 can also be an incorporated display and may function as a touch screen, such as a built-in display of a tablet computer.

Referring now to FIG. 9, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. The types of computing devices 54A-N shown in FIG. 9 are intended to be illustrative only and that cloud computing nodes 10 and cloud computing environment 50 can communicate with any type of computerized device over any type of network and/or network addressable connection (e.g., using a web browser).

Referring now to FIG. 10, a set of functional abstraction layers provided by cloud computing environment 50 (FIG. 9) is shown. The components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and sampling system environment 96.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds). A cloud computing environment is service oriented with a focus on statelessness, low coupling, modularity, and semantic interoperability. At the heart of cloud computing is an infrastructure comprising a network of interconnected nodes.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
retrieving, by one or more computer systems, a first data record from a first population dataset that includes a number of data records, and a second data record from a second population dataset that includes a number of data records;
generating, by the one or more computer processors, a first random seed for the first data record by applying a first mapping function to values of elements in the first data record, and a second random seed for the second data record by applying a second mapping function to values of elements in the second data record, wherein, responsive to determining that the elements in the first data record represent the same data as the elements in the second data record, a value of the first random seed is equal to a value the second random seed;
generating, by the one or more computer processors, a first sampling parameter for the first data record and a second sampling parameter for the second data record using a random number generator, wherein, responsive to determining that the value of the first random seed is equal to the value of the second random seed, the first sampling parameter is equal to the second sampling parameter;
responsive to determining that the first sampling parameter fulfills a sampling rule, selecting, by the one or more computer processors, the first data record for a first sample dataset; and
responsive to determining that the second sampling parameter fulfills the sampling rule, selecting, by the one or more computer processors, the second data record for a second sample dataset.

2. The method of claim 1, wherein generating the first random seed for the first data record by applying the first mapping function to the values of the elements in the first data record, and the second random seed for the second data record by applying the second mapping function to the values of the elements in the second data record comprises:
determining, by the one or more computer processors, whether the values of the elements in the first data record and the values of the elements in the second data record are in a numerical format;
responsive to determining that the values of the elements in the first data record and the values of the elements in the second data record are not in a numerical format, formatting, by the one or more computer processors, the values of the elements in the first data record and the values of the elements in the second data record into the numerical format; and
responsive to determining that the values of the elements in the first data record and the values of the elements in the second data record are in the numerical format, generating, by the one or more computer processors, the first random seed for the first data record by applying the first mapping function to the values of the elements in the first data record, and the second random seed for the second data record by applying the second mapping function to the values of the elements in the second data record, wherein a mapping function is a function of a data record that is in a numeric format.

3. The method of claim 1, wherein the first sampling parameter is generated by initializing the random number generator with the first random seed and the second sampling parameter is generated by initializing the random number generator with the second random seed.

4. The method of claim 1, further comprising:
responsive to determining that the first data record is not selected for the first sample dataset, retrieving, by the one or more computer processors, a next data record from the first population dataset;
responsive to determining that the second data record is not selected for the second sample dataset, retrieving, by the one or more computer processors, a next data record from the second population dataset;
responsive to determining that a sampling parameter for the next data record of the first population dataset fulfills the sampling rule, selecting, by the one or more computer processors, the next data record of the first population dataset for the first sample dataset; and
responsive to determining that a sampling parameter for the next data record of the second population dataset fulfills the sampling rule, selecting, by the one or more computer processors, the next data record of the second population dataset for the second sample dataset.

5. The method of claim 1, further comprising:
responsive to determining that a number of data records for the first sample set is equal to a specified sample dataset size, completing, by the one or more computer processors, generation of the first sample dataset;
responsive to determining that a number of data records for the second sample set is equal to the specified sample dataset size, completing, by the one or more computer processors, generation of the second sample dataset;
responsive to determining that the number of data records for the first sample dataset does not exceed the specified sample dataset size, retrieving, by the one or more computer processors, a next data record from the first population dataset; and
responsive to determining that the number of data records for the second sample dataset does not exceed the specified sample dataset size, retrieving, by the one or more computer processors, a next data record from the second population dataset.

6. The method of claim 1, wherein the first mapping function is the same as the second mapping function, responsive to determining that the elements in the first data record represent the same data as the elements in the second data record.

7. The method of claim 2, wherein formatting the values of the elements in the first data record and the values of the elements in the second data record into the numerical format comprises:
applying, by the one or more computer processors, a hash function to the values of the elements in the first data record and to the values of the elements in the second data record, such that a result of the hash function is in a numerical format.

8. A computer program product comprising:
one or more computer readable storage media and program instructions stored on the one or more computer readable storage media, the program instructions comprising:
program instructions to retrieve a first data record from a first population dataset that includes a number of data records, and a second data record from a second population dataset that includes a number of data records;
program instructions to generate a first random seed for the first data record by applying a first mapping function to values of elements in the first data record, and a second random seed for the second data record by applying a second mapping function to values of elements in the second data record, wherein, responsive to determining that the elements in the first data record represent the same data as the elements in the second data record, a value of the first random seed is equal to a value the second random seed;
program instructions to generate a first sampling parameter for the first data record and a second sampling parameter for the second data record using a random number generator, wherein, responsive to determining that the value of the first random seed is equal to the value of the second random seed, the first sampling parameter is equal to the second sampling parameter;
program instructions to, responsive to determining that the first sampling parameter fulfills a sampling rule, select the first data record for a first sample dataset; and
program instructions to, responsive to determining that the second sampling parameter fulfills the sampling rule, select the second data record for a second sample dataset.

9. The computer program product of claim 8, wherein the program instructions to generate the first random seed for the first data record by applying the first mapping function to the values of the elements in the first data record, and the second random seed for the second data record by applying the second mapping function to the values of the elements in the second data record comprise:
program instructions to determine whether the values of the elements in the first data record and the values of the elements in the second data record are in a numerical format;
program instructions to, responsive to determining that the values of the elements in the first data record and the values of the elements in the second data record are not in a numerical format, format the values of the elements in the first data record and the values of the elements in the second data record into the numerical format; and
program instructions to, responsive to determining that the values of the elements in the first data record and the values of the elements in the second data record are in the numerical format, generate the first random seed for the first data record by applying the first mapping function to the values of the elements in the first data record, and the second random seed for the second data record by applying the second mapping function to the values of the elements in the second data record, wherein a mapping function is a function of a data record that is in a numeric format.

10. The computer program product of claim 8, wherein the first sampling parameter is generated by initializing the random number generator with the first random seed and the second sampling parameter is generated by initializing the random number generator with the second random seed.

11. The computer program product of claim 8, wherein the program instructions stored on the one or more computer readable storage media further comprise:
program instructions to, responsive to determining that the first data record is not selected for the first sample dataset, retrieve a next data record from the first population dataset;
program instructions to, responsive to determining that the second data record is not selected for the second sample dataset, retrieve a next data record from the second population dataset;
program instructions to, responsive to determining that a sampling parameter for the next data record of the first population dataset fulfills the sampling rule, select the next data record of the first population dataset for the first sample dataset; and
program instructions to, responsive to determining that a sampling parameter for the next data record of the second population dataset fulfills the sampling rule, select the next data record of the second population dataset for the second sample dataset.

12. The computer program product of claim 8, wherein the program instructions stored on the one or more computer readable storage media further comprise:
program instructions to, responsive to determining that a number of data records for the first sample set is equal to a specified sample dataset size, complete generation of the first sample dataset;
program instructions to, responsive to determining that a number of data records for the second sample set is equal to the specified sample dataset size, complete generation of the second sample dataset;
program instructions to, responsive to determining that the number of data records for the first sample dataset does not exceed the specified sample dataset size, retrieve a next data record from the first population dataset; and
program instructions to, responsive to determining that the number of data records for the second sample dataset does not exceed the specified sample dataset size, retrieve a next data record from the second population dataset.

13. The computer program product of claim 8, wherein the first mapping function is the same as the second mapping function, responsive to determining that the elements in the first data record represent the same data as the elements in the second data record.

14. The computer program product of claim 9, wherein formatting the values of the elements in the first data record and the values of the elements in the second data record into the numerical format comprise:
program instructions to apply a hash function to the values of the elements in the first data record and to the values of the elements in the second data record, such that a result of the hash function is in a numerical format.

15. A computer system comprising:
one or more computer processors;
one or more computer readable storage media;
program instructions stored on the computer readable storage media for execution by at least one of the one or more processors, the program instructions comprising:
program instructions to retrieve a first data record from a first population dataset that includes a number of data records, and a second data record from a second population dataset that includes a number of data records;
program instructions to generate a first random seed for the first data record by applying a first mapping function to values of elements in the first data record, and a second random seed for the second data record by applying a second mapping function to values of elements in the second data record, wherein, responsive to determining that the elements in the first data record represent the same data as the elements in the second data record, a value of the first random seed is equal to a value the second random seed;
program instructions to generate a first sampling parameter for the first data record and a second sampling parameter for the second data record using a random number generator, wherein, responsive to determining that the value of the first random seed is equal to the value of the second random seed, the first sampling parameter is equal to the second sampling parameter;
program instructions to, responsive to determining that the first sampling parameter fulfills a sampling rule, select the first data record for a first sample dataset; and
program instructions to, responsive to determining that the second sampling parameter fulfills the sampling rule, select the second data record for a second sample dataset.

16. The computer system of claim 15, wherein the program instructions to generate the first random seed for the first data record by applying the first mapping function to the values of the elements in the first data record, and the second random seed for the second data record by applying the second mapping function to the values of the elements in the second data record comprise:
program instructions to determine whether the values of the elements in the first data record and the values of the elements in the second data record are in a numerical format;
program instructions to, responsive to determining that the values of the elements in the first data record and the values of the elements in the second data record are not in a numerical format, format the values of the elements in the first data record and the values of the elements in the second data record into the numerical format; and
program instructions to, responsive to determining that the values of the elements in the first data record and the values of the elements in the second data record are in the numerical format, generate the first random seed for the first data record by applying the first mapping function to the values of the elements in the first data record, and the second random seed for the second data record by applying the second mapping function to the values of the elements in the second data record, wherein a mapping function is a function of a data record that is in a numeric format.

17. The computer system of claim 15, wherein the first sampling parameter is generated by initializing the random number generator with the first random seed and the second sampling parameter is generated by initializing the random number generator with the second random seed.

18. The computer system of claim 15, wherein the program instructions stored on the one or more computer readable storage media further comprise:
program instructions to, responsive to determining that the first data record is not selected for the first sample dataset, retrieve a next data record from the first population dataset;
program instructions to, responsive to determining that the second data record is not selected for the second sample dataset, retrieve a next data record from the second population dataset;
program instructions to, responsive to determining that a sampling parameter for the next data record of the first population dataset fulfills the sampling rule, select the next data record of the first population dataset for the first sample dataset; and
program instructions to, responsive to determining that a sampling parameter for the next data record of the second population dataset fulfills the sampling rule, select the next data record of the second population dataset for the second sample dataset.

19. The computer system of claim 15, wherein the program instructions stored on the one or more computer readable storage media further comprise:
program instructions to, responsive to determining that a number of data records for the first sample set is equal to a specified sample dataset size, complete generation of the first sample dataset;
program instructions to, responsive to determining that a number of data records for the second sample set is equal to the specified sample dataset size, complete generation of the second sample dataset;
program instructions to, responsive to determining that the number of data records for the first sample dataset does not exceed the specified sample dataset size, retrieve a next data record from the first population dataset; and
program instructions to, responsive to determining that the number of data records for the second sample dataset does not exceed the specified sample dataset size, retrieve a next data record from the second population dataset.

20. The computer system of claim 15, wherein the first mapping function is the same as the second mapping function, responsive to determining that the elements in the first data record represent the same data as the elements in the second data record.
